(19) United States
(12) Patent Application Publication
(10) Pub. No.: US 2017/0154279 A1
(43) Pub. Date: Jun. 1, 2017

(54) CHARACTERIZING SUBPOPULATIONS BY EXPOSURE RESPONSE

(71) Applicant: International Business Machines Corporation, Armonk, NY (US)

(72) Inventors: Ranit Y. Aharonov, Tel Aviv (IL); Tal El-Hay, Modi'in (IL); Michal Flato, Tel Aviv (IL); Ya'ara Goldschmidt, Kiryat Ono (IL); Naama Parush Shear-Yashuv, Neve-Daniel (IL); Michal Rosen-Zvi, Jerusalem (IL)

(21) Appl. No.: 14/953,514

(22) Filed: Nov. 30, 2015

(51) Int. Cl. G06N 99/00; G06N 7/00

(52) U.S. Cl. CPC G06N 99/005; G06N 7/005

(57) ABSTRACT

Characterizing subpopulations by their response to a given exposure relative to an alternative. Data for a set of subjects is received, including two exposures, two outcomes, and a set of characteristics. For a number of subsets an outcome model that estimates the probability of an outcome, given an exposure and the characteristics, is trained; an individual odds ratio (iOR), based on the outcome model, is computed; a sparse model that classifies subjects into a high-iOR group or another group is trained; the characteristics used in the sparse model are recorded; and, based on the recorded characteristics, a primary set of characteristics is selected. Another outcome model, based on the set of subjects and the characteristics, is trained. An iOR based on the other outcome model is computed. A sparse model for classifying subjects into a high-iOR group or another group, using the primary set of characteristics, is trained.

### BACKGROUND

The present invention relates generally to the field of medical informatics, and more particularly to characterizing subpopulations by response to a given exposure relative to an alternative.

Testing the effect of an exposure on an outcome in a given population is a fundamental problem in data analysis. This problem is applicable in various domains for comparing two alternative exposures, such as medical treatments, insurance policies, marketing strategies, etc. The question in general is which exposure has a higher chance of leading to a better (or worse) outcome.

Many studies test the effect on an outcome of one exposure, or treatment, versus an alternative in a given population. Various statistical methods have been employed to eliminate extraneous, or confounding, variables in order to elucidate the difference in the effect of one exposure versus an alternative. These methods can also be used to confirm hypotheses made regarding subpopulations suspected as having an elevated relative response. However, these methods are generally not designed to generate such hypotheses, only to validate them.

### SUMMARY

Embodiments of the present invention disclose a computer-implemented method, system, and computer program product for characterizing subpopulations by their response to a given exposure relative to an alternative. A global dataset including data for a set of subjects is received. The data associated with the subjects includes one of two exposures, one of two outcomes, and population characteristics. A primary set of population characteristics, based on sparse machine learning models associated with subsets of the global dataset, is determined as follows: Outcome machine learning models, which estimate a preliminary probability of an outcome, given an exposure and the population characteristics associated with subjects in the subset, are trained on the subsets. Based on the preliminary probabilities estimated by the outcome machine learning model, a preliminary individual odds ratio (iOR) for subjects in the subsets, which measures the odds of the first outcome given the first exposure relative to the odds of the first outcome given the second exposure, is computed. Each subset is split into a preliminary high-iOR group and a preliminary further group. Sparse machine learning models, which classify the subjects in the subsets into the preliminary high-iOR group or the preliminary further group, are trained on the subsets. Population characteristics used in the sparse machine learning models are recorded. The primary set of population characteristics is selected, based on the recorded population characteristics. A primary sparse machine learning model, based on the primary set of population characteristics is created as follows: Another outcome machine learning model based on the global dataset, which estimates a primary probability of an outcome, given an exposure and the population characteristics associated with the subjects in the global dataset is trained. A primary iOR for subjects in the global dataset, based on the probability of the outcome estimated by the other outcome machine learning model, which measures the odds of the first outcome given the first exposure relative to the odds of the first outcome given the second exposure, is computed. The global dataset is split into a high-iOR group and a further group. A primary sparse machine learning model, which classifies subjects in the global dataset into the high-iOR group or the further group, based on the primary set of population characteristics, is trained.

### BRIEF DESCRIPTION OF THE DRAWINGS

FIG. 1 depicts a functional block diagram of a response group characterization system, in accordance with an embodiment of the present invention.

FIG. 2 is a flowchart depicting operational steps of a response group characterization program, in accordance with an embodiment of the present invention.

FIG. 3 is a further flowchart depicting further operational steps of a response group characterization program, in accordance with an embodiment of the present invention.

FIG. 4 is a functional block diagram illustrating a data processing environment, in accordance with an embodiment of the present invention.

### DETAILED DESCRIPTION

An extension of the problem of determining which of two exposures has a higher chance of leading to a better (or worse) outcome is identifying subpopulations for which a given exposure has a better (or worse) effect with respect to an alternative. In other words, the problem is to characterize subpopulations with a high (or low) relative response to the given exposure with respect to the alternative. This problem becomes very challenging when the number of population characteristics is large, such as is the case in electronic medical records data.

Various methods exist for characterizing responders to a given exposure without comparison to an alternative exposure or a control. These methods are typically applied to populations of treated patients, comparing good responders to bad responders. However, they do not consider alternative treatments. It may be the case that someone who is characterized as being a good responder to treatment A is also a good responder to treatment B. Since a comparison with an alternative treatment is missing, it is generally not possible to pinpoint population characteristics associated with a good response that are specific to the given treatment.

The computer-implemented methods, systems, and computer program products disclosed herein would provide a readily interpretable characterization, involving a small number of key population characteristics, of subpopulations with a high relative response to an exposure relative to an alternative. Such a characterization may be used, for example, to generate hypotheses regarding factors that result in an elevated response. The hypotheses, when validated, may be used to identify an optimal subpopulation with respect to the exposure and a set of highly predictive population characteristics.

Embodiments of the present invention disclose a computer-implemented method, computer program product, and system for characterizing subpopulations that show a high/low relative success rate for a given exposure versus an alternative. The method may include two main procedures: The first procedure may estimate an individual odds ratio (iOR), representing the expected response of an individual, or subject, to one exposure relative to the alternative. The iOR is estimated using a first kind of machine learning model, an outcome model, learned from a training set of observational data, from, for example, a non-randomized study, that predicts the success rate for a subject, given the exposure and a set of population characteristics. The second procedure may use the iOR to construct a second kind of machine learning model, a sparse population characterization model, by splitting the population into two subpopulations, a high iOR group and a further group, for example, a disjoint complementary group, and may train the model to differentiate between the two groups. A sparse model in this case refers to one that is based on a subset of population characteristics that is small relative to the set of population characteristics used in the outcome model.

These two procedures may be executed with resampling, or bootstrapping, on multiple subsamples, and the top-appearing resulting population characteristics are selected, to end up with a robust and small subset of population characteristics. The steps may end by fitting a sparse model on the entire training data using the selected population characteristics, which may be used to devise a relative response score (RRS). Thus, these steps may constitute a hypothesis generation step, in which a machine learning pipeline is applied on the training set to learn an interpretable function, based on a small number of population characteristics, that may be used to stratify subjects into different groups according to RRS.

Embodiments of the present invention may be viewed as a machine learning pipeline, which may include several steps whose input is observational data on a set of subjects, where for each subject the following information is available:
(1) Whether the subject was exposed to exposure 1 (T1) or exposure 2 (T2).
(2) Observational data (e.g., age, gender, past exposures, etc.), from which population characteristics associated with the subject, can be extracted.
(3) Binary outcome of the exposure, i.e., success or failure.

The machine learning pipeline may answer the question of what affects the direction (i.e., positive or negative) and magnitude of a response to T1 vs. T2, and may be used to devise an RRS. The RRS may allow one to predict, for a subject, the relative success of exposure T1 vs. exposure T2. Based on the RRS, one can take a population of subjects and divide it into subpopulations that respond better/worse/same, or more generally at some level of difference (e.g., better by an amount or percentage, worse by an amount or percentage, etc.) to T1 vs. T2 with respect to a defined outcome. This is sometimes referred to as stratification. Stratification based on RRS may provide a robust and interpretable characterization of subpopulations by exposure response.

Machine learning is a field of computer science and statistics that involves the construction of algorithms that learn from and make predictions about data. Rather than following explicitly programmed instructions, machine learning methods operate by building a model using selected, known inputs, and using the model to make predictions or decisions about unknown inputs. Classification is a machine learning task concerned with the problem of identifying to which of a set of categories, or classes, an input belongs. Common applications of classification include spam filtering and optical character recognition. Logistic regression is a common technique for binary classification, in which inputs are assigned to one of two classes, for example, spam or not spam. In what follows, the term model refers to a machine learning model.

In supervised machine learning, a classification function may be inferred, or trained, from a set of labeled training data. The training data consists of training examples, typically pairs of input objects and desired output objects, for example class labels. During training, the parameters of the model are adjusted, usually iteratively, so that inputs are assigned to one or more of the classes to some degree of accuracy, based on a predefined metric. The inferred classification function can then be used to classify new examples.

The binary logistic model may be used to predict a binary response Y, for example, exposure success, based on one or more predictor variables, x, which may be continuous or categorical. The predictor variables may include, for example, population, or subject, characteristics and exposures. The probabilities describing the two possible outcomes are modeled as a function of the predictor variables x, using a logistic function of the form

Pr(Y=1|x)=(1+exp(−α′x−β))⁻¹

where α is a model parameter vector and β is a scalar offset parameter. Binary logistic regression refers to the problem of determining a logistic function of x when the dependent variable is binary, that is the observed outcome for the dependent variable, such as a label or class, can have only one of two possible values, such as success or failure. In this case, an object associated with predictor variables x is usually assigned to the class associated with Y=1 if and only if Pr(Y=1|x)≧0.5.

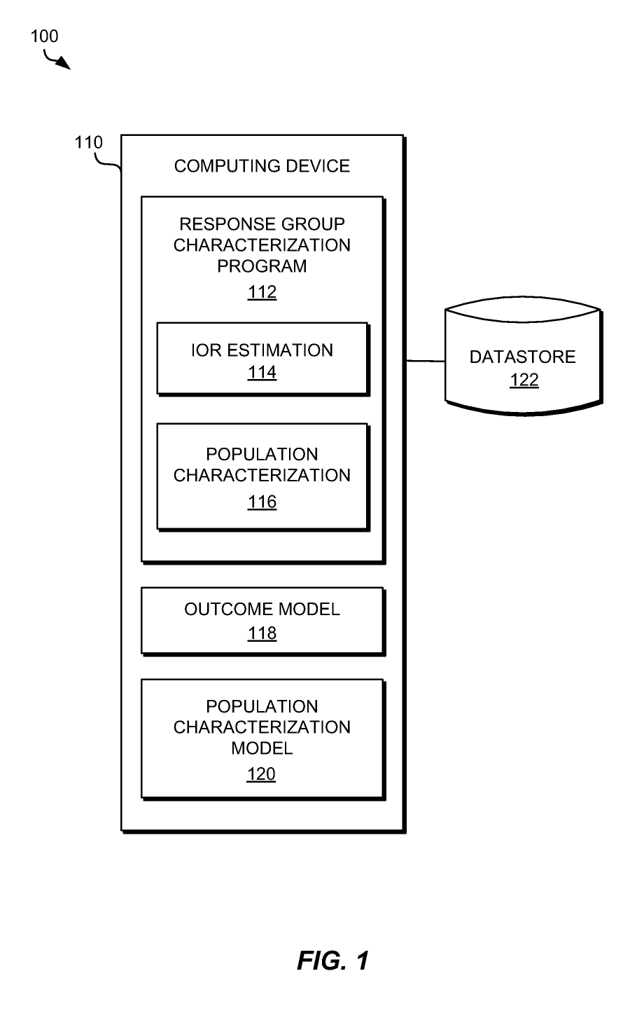

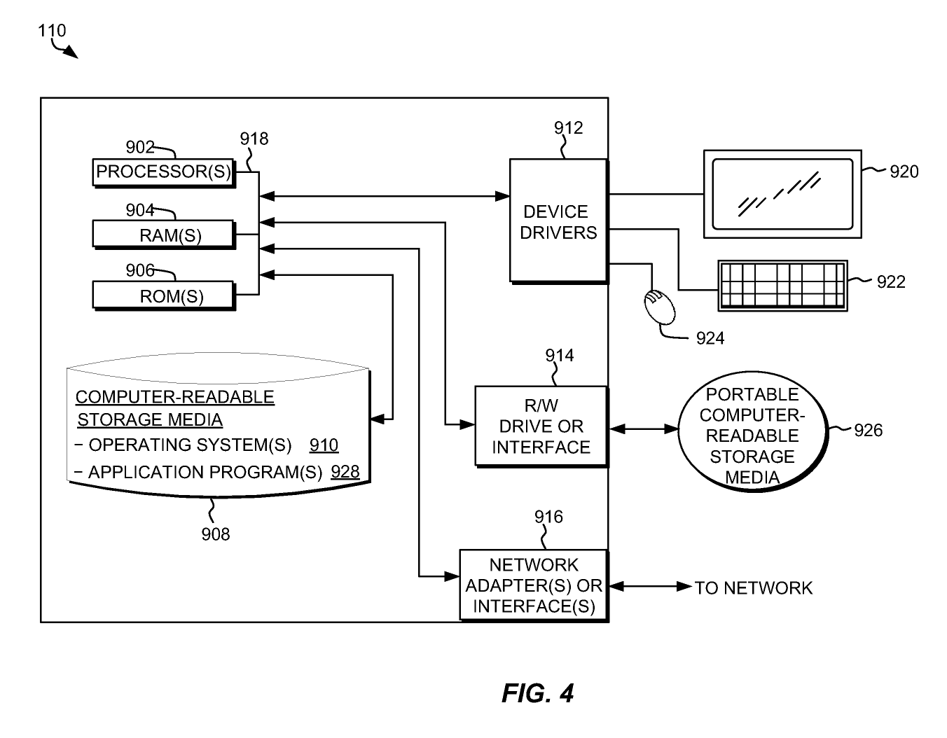

FIG. 1 is a functional block diagram of a response group characterization system 100, in accordance with an embodiment of the present invention. Response group characterization system 100 includes computing device 110. Computing device 110 represents the computing environment or platform that hosts response group characterization program 112. In various embodiments, computing device 110 may be a laptop computer, netbook computer, personal computer (PC), a desktop computer, or any programmable electronic device capable of hosting response group characterization program 112, in accordance with embodiments of the invention. Computing device 110 may include internal and external hardware components, as depicted and described in further detail below with reference to FIG. 4.

In an exemplary embodiment of the invention, computing device 110 includes response group characterization program 112, outcome model 118, population characterization model 120, and datastore 122.

Datastore 122 represents a store of observational, or training, data, with known exposure and outcome, in accordance with an embodiment of the present invention. For example, datastore 122 may include medical data for many patients, with known treatments and outcomes. Datastore 122 may reside, for example, on computer readable storage media 908 (FIG. 4).

In an embodiment of the invention, outcome model 118 represents a machine learning model, trained to apply a binary classification algorithm, such as logistic regression, in which individuals, or subjects, are classified into two groups, corresponding to success or failure. Outcome model 118 may use, for example, supervised learning with labeled data from observational data stored in datastore 122, consisting of subjects paired with labels that identify them as being associated with a successful or unsuccessful outcome. Outcome model 118 may be trained, for example, using observational data for a subset of subjects using selected population characteristics, via regularized logistic regression. Outcome model 118 estimates the probability of exposure success Pr(Y=1|E=e, x), in accordance with an embodiment of the invention. Here, the variable Y indicates the outcome, Y=1 for success, Y=0 for failure, E indicates the exposure, E=1 for T1, E=0 for T2, and x represents population characteristics.

In an embodiment of the invention, a representative subset of population characteristics, or features, for outcome model 118 may be selected initially based on filtering constant features and a significant association with an outcome. For example, a feature may be deemed constant, and eliminated, if its mode frequency is greater than 0.99. In addition, standard statistical tests may be used to select label-informative population characteristics, those most significantly associated with a label, i.e., outcome. For example, a t-test for continuous and a chi-square test for categorical population characteristics may be employed. For example, features with P-values <0.05 may be selected, and a bound on the maximum inter-feature Pearson correlation coefficient of 0.99 may be set. After an initial filter feature selection step, the resulting representative subset of population characteristics may be extended with interaction terms that include the product of exposure indicator E with every selected feature. These features may be filtered again using the above procedures.

Population characterization model 120 represents a machine learning model for classifying subjects as belonging to or not belonging to a high-iOR group with respect to treatment T1, where the iOR is estimated using outcome model 118. In an embodiment of the invention, population characterization model 120 is a sparse model that estimates the probability of a subject belonging to the high-iOR group.

In an embodiment of the invention, population characteristics, or features, for population characterization model 120 may be selected initially based on filtering constant population characteristics, as described above, and significant association with high-iOR group membership, to allow inclusion of population characteristics that are not directly associated with outcome, but could theoretically be associated with group differences in responses to different exposures. To reduce the number of population characteristics, the inter-feature correlation bound may be set, for example, to 0.5.

Population characterization model 120 may be trained, for example, using forward feature selection and logistic regression. For subsamples, sparseness may be imposed by setting the stop criterion according to the number of selected population characteristics. For example, forward feature selection may cease when a predetermined number, e.g., seven population characteristics, have been selected. It will be appreciated that this example is non-limiting and other numbers of features are contemplated.

Response group characterization program 112, in an embodiment of the invention, operates generally to estimate an iOR for a set of subjects using outcome model 118. It may then use the iOR to construct population characterization model 120, a sparse model for classifying subjects as belonging, or not, to a high-iOR group with respect to treatment T1. Response group characterization program 112 may include iOR estimation module 114 and population characterization module 116.

IOR estimation module 114 operates generally to estimate for a subject an iOR, the expected relative response of a subject to one exposure versus the alternative. The iOR may be estimated using outcome model 118, which may be trained to predict the success rate of a subject given an exposure.

IOR estimation module 114 may receive observational data on a set of subjects, including whether the subject was exposed to exposure T1 or exposure T2; population characteristics, such as age, gender, prior exposures, etc.; and outcome, i.e., whether the exposure was determined to be successful or not. From the set of subjects, a random subset, or subsample, of the observational data may be selected. For example, a subset representing a fixed percentage, such as 75%, of the entire set, or population, of subjects may be randomly chosen. Outcome model 118 may be trained using the random subsample with an initial subset of the population characteristics, for example, those deemed likely to be informative, based on standard statistical tests. For each subject, an iOR, which measures the expected relative response of a subject to exposure T1 (E=1) versus exposure T2 (E=0), may be computed by equation (1):

$$iOR ( x ) = \frac{Pr ( Y = 1 \vert E = 1 , x )}{Pr ( Y = 0 \vert E = 1 , x )} / \frac{Pr ( Y = 1 \vert E = 0 , x )}{Pr ( Y = 0 \vert E = 0 , x )} \qquad ( 1 )$$

That is, iOR represents the odds of success with exposure T1 relative to the odds of success with exposure T2.

It will be appreciated that the terms random and randomly chosen contemplate both a true random process and a pseudo-random process as commonly implemented in a computer algorithm or program. Moreover, in an alternative embodiment subsamples may be chosen in a non-random manner, for example, according to a predetermined scheme or any other non-random manner of selection known or contemplated.

Population characterization module 116 may split a subsample into a high-iOR group and its complement, a not-high-iOR group, based on a predetermined threshold, using the iOR values computed by iOR estimation module 114. For example, the high-iOR group may include those subjects with iOR above the group median or the group mean, or above a predetermined iOR value. Population characterization module 116 may train population characterization model 120, a sparse model for classifying subjects in the subsample into the high-iOR group or its complement, the not-high-iOR group. For this purpose, population characterization module 116 may use, for example, forward feature selection or stepwise feature selection, with a binary classifier based on logistic regression. Population characterization module 116 may select as an initial set of the population characteristics those deemed likely to be informative, based on standard statistical tests.

To train a sparse population characterization model 120, response group characterization program 112 may select the features of population characterization model 120 using a principle that relates stability to robustness of feature selection. Stable features may be selected by applying a resampling method that produces random subsamples and applies a feature selection algorithm that gives a good characterization on each subsample. Response group characterization program 112 may select a primary subset of population characteristics, for example, from those that appear in a proportion of the processed subsamples that is higher than a predetermined threshold, for example, 20%. A higher percentage corresponds to a higher degree of sparsity.

Using the population characteristics available in the original observational data on the set of subjects, iOR estimation module 114 may train outcome model 118 on the entire set of subjects. Based on outcome model 118, iOR estimation module 114 may compute for each subject an iOR according to equation (1), above.

Population characterization module 116 may split the entire set of subjects into a high-iOR group and its complement, a not-high-iOR group, based on a predetermined threshold, using the iOR values computed by iOR estimation module 114. Population characterization module 116 may train population characterization model 120, a sparse model for classifying subjects in the entire set of subjects into the high-iOR group or its complement, using the primary subset of population characteristics.

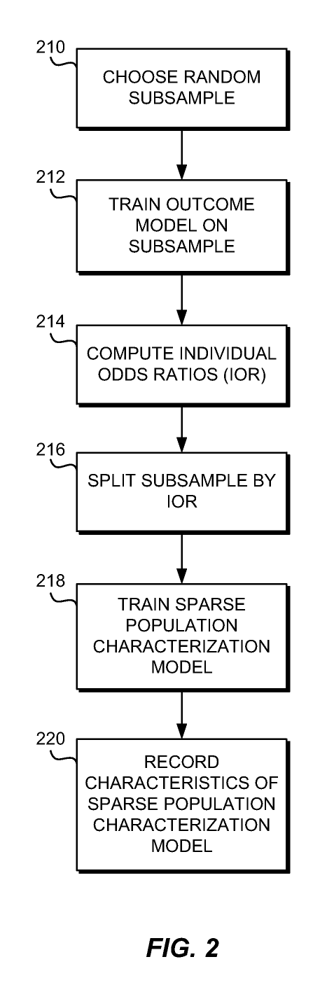

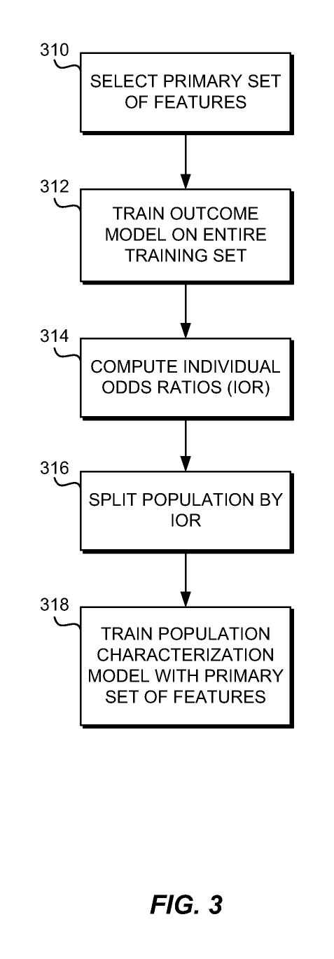

FIGS. 2 and 3 FIG. 2 are flowcharts depicting various operational steps performed by computing device 110 in executing response group characterization program 112, in accordance with an exemplary embodiment of the invention. In various embodiments of the invention, FIG. 2 represents part 1 of a process, which may be performed one or more times. Part 1 of the process may result in one or more subsets of population characteristics, from which a primary subset of population characteristics may be chosen. FIG. 3 represents part 2 of the process, in which a sparse population characterization model, based on the primary subset of population characteristics, may be created.

FIG. 2 is a flowchart depicting various operational steps performed by computing device 110 in executing a first part of a process, for example, performed by response group characterization program 112, in accordance with an exemplary embodiment of the invention. Response group characterization program 112 may receive from datastore 122 observational data on a set of subjects, a global dataset, including exposure, population characteristics, and outcome. From the global dataset, iOR estimation module 114 may select a random subset, or subsample, from the observational data received from datastore 122 (step 210). IOR estimation module 114 may train outcome model 118 using the subsample (step 212) for a subset of population characteristics. For example, outcome model 118 may be trained on population characteristics deemed likely to be informative, using regularized logistic regression. Based on outcome model 118, iOR estimation module 114 may compute, for each subject in the subsample, an iOR, which measures the expected relative response of a subject to exposure T1 versus exposure T2 (step 214). Population characterization module 116 may split subjects in the subsample into a high-iOR group and its complement (step 216), based on a predetermined threshold. Population characterization module 116 may train population characterization model 120, a sparse model for classifying subjects in the subsample into the high-iOR group or its complement (step 218). The population characteristics selected in the sparse model may be recorded (step 220). Steps 210-220 of FIG. 2 may be repeated a predetermined number of times, each time randomly choosing a new subsample.

FIG. 3 is a flowchart depicting further operational steps performed by computing device 110 in executing a second part of a process, for example, performed by response group characterization program 112, in accordance with an exemplary embodiment of the invention. A primary set of population characteristics may be chosen from the recorded population characteristics of one or more subsamples (step 310). For example, only those population characteristics that were selected in at least a given percentage, e.g., 20%, of the subsamples may be chosen. A procedure similar to that depicted in FIG. 2, steps 212-218, may be followed in steps 312-318, except that the entire population of subjects may be used, and in step 318 the population characteristics in the primary set may be used. For example, iOR estimation module 114 may train an outcome model 118 on the entire training set, e.g., the global dataset, using a representative subset of the population characteristics (step 312). For example, the representative subset may include all the population characteristics that remain after an initial filtering step, as described above. IOR estimation module 114 may compute individual odds ratios for each subject in the training set (step 314). Population characterization module 116 may split the population into a high-iOR group and a further group, for example, a not-high-iOR group, for example, based on a predetermined threshold (step 316). Population characterization module 116 may train a primary population characterization model 120 for classifying subjects in the entire population into the high-iOR group or the further group, using the primary subset of population characteristics (step 318).

For example, in a particular non-limiting implementation, an appropriate value for the number of subsamples may be 50, with a resampling method that produces random subsamples containing 75% of the training data. For the outcome model, regularized logistic regression may be used. A ridge penalty parameter sufficiently large to avoid over-fitting, as well as to allow good generalization in a high-dimensional setting, may be chosen.

In various embodiments, based on the primary population characterization model, an RRS, which corresponds to the probability of a subject belonging to the high-iOR group, may be computed. For example, the RRS may be a linear combination of the small number of stable population characteristics selected, with the coefficients taken from the logistic regression.

In one embodiment of the present invention observational data on a set of subjects is received, including one of two exposures, one of two outcomes, and a set of population characteristics. A subset of the population characteristics associated with one or more random subsets of the set of subjects is determined as follows. For each random subset, a machine learning model that estimates the probability of an outcome, given an exposure and the population characteristics, is trained on the random subset. An individual odds ratio (iOR), which measures odds of the first outcome with the first exposure, relative to odds of the first outcome with the second exposure, is computed. The random subset is split into a high-iOR group and another group. A sparse machine learning model for classifying subjects into the high-iOR group or its complement is trained, and the population characteristics used in the sparse machine learning model are recorded. Based on the recorded population characteristics, a final set of population characteristics is selected. A machine learning model that estimates for each subject in the set of subjects the probability of an outcome, given an exposure and a representative subset of the population characteristics, as described above, is trained. The set of subjects is split into a high-iOR group and another group. A machine learning model for classifying subjects in the set into the high-iOR group or its complement, using the final set of population characteristics, is trained.

In various embodiments, an additional validation step may be carried out, based on the RRS. A validation set of subjects, independent of the training set, is stratified, based on individual RRS values. The effect size of the exposure for each of the groups is estimated, and it is validated that the effect size, indeed, increases for groups with higher RRS values.

It will be appreciated that outcome model 118 and population characterization model 120 each may represent various machine learning models, which may differ, for example, based on the training sets on which they are trained, their form and parameters, and their inputs.

FIG. 4 depicts a block diagram of components of a computing device 110, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Computing device 110 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 928, for example, response group characterization program 112, are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 110 may also include a R/W drive or interface 914 to read from and write to one or more portable computer readable storage media 926. Application programs 928 on computing device 110 may be stored on one or more of the portable computer readable storage media 926, read via the respective R/W drive or interface 914 and loaded into the respective computer readable storage media 908.

Computing device 110 may also include a network adapter or interface 916, such as a TCP/IP adapter card or wireless communication adapter (such as a 4G wireless communication adapter using OFDMA technology). Application programs 928 on computing device 110 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing device 110 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user s. The device drivers 912, R/W drive or interface 914 and network adapter or interface 916 may comprise hardware and software (stored on computer readable storage media 908 and/or ROM 906).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The foregoing description of various embodiments of the present invention has been presented for purposes of illustration and description. It is not intended to be exhaustive nor to limit the invention to the precise form disclosed. Many modifications and variations are possible. Such modification and variations that may be apparent to a person skilled in the art of the invention are intended to be included within the scope of the invention as defined by the accompanying claims.

What is claimed is:

1. A computer-implemented method for characterizing subpopulations by their response to a given exposure relative to an alternative, the method comprising:
receiving, by a computer, a global dataset comprising data for subjects associated with an exposure and an outcome, and population characteristics associated with the subjects, wherein the exposure is selected from the group consisting of a first exposure and a second exposure, and the outcome is selected from the group consisting of a first outcome and a second outcome;
determining, by the computer, a primary set of population characteristics based on one or more sparse machine learning models respectively associated with one or more subsets of the global dataset, wherein the determining comprises:
training one or more outcome machine learning models based on the one or more subsets, wherein an outcome machine learning model is trained on a respective subset, and the outcome machine learning model estimates a preliminary probability of the outcome, given the exposure and the population characteristics associated with the subjects in the subset;
computing a preliminary individual odds ratio (iOR) for subjects in the one or more subsets, wherein the preliminary iOR is based on the preliminary probability estimated by the outcome machine learning model trained on the respective subset, and wherein the preliminary iOR measures odds of the first outcome being associated with the first exposure, relative to odds of the first outcome being associated with the second exposure;
splitting the one or more subsets, respectively, into a preliminary high-iOR group and a preliminary further group;
training one or more sparse machine learning models based on the one or more subsets, wherein a sparse machine learning model is trained on the respective subset, and the sparse machine learning model classifies the subjects in the respective subset into the preliminary high-iOR group or the preliminary further group;
recording population characteristics used in the one or more sparse machine learning models trained on the one or more subsets; and
selecting the primary set of population characteristics based on the recorded population characteristics used in the one or more sparse machine learning models trained on the one or more subsets; and
creating, by the computer, a primary sparse machine learning model based on the primary set of population characteristics, wherein the creating comprises:
training another outcome machine learning model based on the global dataset, wherein the another outcome machine learning model estimates a primary probability of the outcome, given the exposure and the population characteristics associated with the subjects in the global dataset;
computing a primary iOR for subjects in the global dataset, wherein the primary iOR is based on the primary probability estimated by the another outcome machine learning model trained on the global dataset, wherein the primary iOR measures odds of the first outcome being associated with the first exposure, relative to odds of the first outcome being associated with the second exposure;
splitting the global dataset into a high-iOR group and a further group; and
training the primary sparse machine learning model based on the global dataset, wherein the primary sparse machine learning model classifies subjects in the global dataset into the high-iOR group or the further group based on the primary set of population characteristics.

2. A method in accordance with claim 1, wherein the one or more subsets of the global dataset comprise a predetermined number of subsets of the global dataset, wherein each subset comprises a predetermined percentage of subjects from the global dataset.

3. A method in accordance with claim 1, wherein the data for the subjects associated with the exposure and the outcome is observational data from a non-randomized study.

4. A method in accordance with claim 1, wherein
training the one or more outcome machine learning models comprises binary classification based on logistic regression.

5. A method in accordance with claim 1, wherein
training the one or more sparse machine learning models comprises binary classification based on logistic regression.

6. A method in accordance with claim 1, wherein
training the another outcome machine learning models comprises binary classification based on logistic regression.

7. A method in accordance with claim 1, wherein
training the primary sparse machine learning model comprises binary classification based on logistic regression.

8. A method in accordance with claim 1, wherein
splitting the one or more subsets, respectively, into the preliminary high-iOR group and the preliminary further group comprises splitting the respective subsets based on a threshold that is one of:
the median iOR of the subset; the mean iOR of the subset; or a predetermined iOR value.

9. A method in accordance with claim 1, wherein
splitting the global dataset into the high-iOR group and the further group comprises splitting the global dataset based on a threshold that is one of:
the median iOR of the subset; the mean iOR of the subset; or a predetermined iOR value.

10. A method in accordance with claim 1, wherein
training the one or more sparse machine learning models further comprises a population characteristics selection method selected from the group consisting of forward selection or stepwise selection.

11. A method in accordance with claim 1, wherein selecting the primary set of population characteristics based on the recorded population characteristics comprises:
selecting recorded population characteristics associated with at least a predetermined percentage of the subsets.

12. A method in accordance with claim 1, wherein the preliminary further group is a disjoint group complementing the preliminary high-iOR group.

13. A method in accordance with claim 1, wherein the further group is a disjoint group complementing the high-iOR group.

14. A method in accordance with claim 1, wherein the one or more subsets are randomly selected.

15. A computer system for characterizing subpopulations by their response to a given exposure relative to an alternative, the computer system comprising:
one or more computer processors, one or more non-transitory computer-readable storage media, and program instructions stored on one or more of the computer-readable storage media for execution by at least one of the one or more processors, the program instructions comprising:
program instructions to receive a global dataset comprising data for subjects associated with an exposure and an outcome, and population characteristics associated with the subjects, wherein the exposure is selected from the group consisting of a first exposure and a second exposure, and the outcome is selected from the group consisting of a first outcome and a second outcome;
program instructions to determine a primary set of population characteristics based on one or more sparse machine learning models respectively associated with one or more subsets of the global dataset, comprising:
training one or more outcome machine learning models based on the one or more subsets, wherein an outcome machine learning model is trained on a respective subset, and the outcome machine learning model estimates a preliminary probability of the outcome, given the exposure and the population characteristics associated with the subjects in the subset;
computing a preliminary individual odds ratio (iOR) for subjects in the one or more subsets, wherein the preliminary iOR is based on the preliminary probability estimated by the outcome machine learning model trained on the respective subset, and wherein the preliminary iOR measures odds of the first outcome being associated with the first exposure, relative to odds of the first outcome being associated with the second exposure;
splitting the one or more subsets, respectively, into a preliminary high-iOR group and a preliminary further group;
training one or more sparse machine learning models based on the one or more subsets, wherein a sparse machine learning model is trained on the respective subset, and the sparse machine learning model classifies the subjects in the respective subset into the preliminary high-iOR group or the preliminary further group;
recording population characteristics used in the one or more sparse machine learning models trained on the one or more subsets; and
selecting the primary set of population characteristics based on the recorded population characteristics used in the one or more sparse machine learning models trained on the one or more subsets; and
program instructions to create a primary sparse machine learning model based on the primary set of population characteristics comprising:
training another outcome machine learning model based on the global dataset, wherein the another outcome machine learning model estimates a primary probability of the outcome, given the exposure and the population characteristics associated with the subjects in the global dataset;
computing a primary iOR for subjects in the global dataset, wherein the primary iOR is based on the probability of the outcome estimated by the another outcome machine learning model trained on the global dataset, wherein the primary iOR measures odds of the first outcome being associated with the first exposure, relative to odds of the first outcome being associated with the second exposure;
splitting the global dataset into a high-iOR group and a further group; and
training the primary sparse machine learning model based on the global dataset, wherein the primary sparse machine learning model classifies subjects in the global dataset into the high-iOR group or the further group based on the primary set of population characteristics.

16. A computer system in accordance with claim 15, wherein the one or more subsets of the global dataset comprise a predetermined number of subsets of the global dataset, wherein each subset comprises a predetermined percentage of subjects from the global dataset.

17. A computer system in accordance with claim 15, wherein
training the one or more outcome machine learning models comprises binary classification based on logistic regression.

18. A computer system in accordance with claim 15, wherein
training the one or more sparse machine learning models comprises binary classification based on logistic regression, and
wherein training the one or more sparse machine learning models further comprises a population characteristics selection method selected from the group consisting of forward selection or stepwise selection.

19. A computer system in accordance with claim 15, wherein
splitting the one or more subsets, respectively, into the preliminary high-iOR group and the preliminary further group comprises splitting the respective subsets based on a threshold that is one of:
the median iOR of the subset; the mean iOR of the subset; or a predetermined iOR value.

20. A computer system in accordance with claim 15, wherein
selecting the primary set of population characteristics based on the recorded population characteristics comprises selecting recorded population characteristics associated with at least a predetermined percentage of the subsets.
